(19) United States
(12) Patent Application Publication
(10) Pub. No.: US 2017/0192270 A1
(43) Pub. Date: Jul. 6, 2017

(54) LIQUID CRYSTAL DISPLAY PANEL AND MANUFACTURING METHOD THEREOF

(71) Applicants: BOE TECHNOLOGY GROUP CO., LTD., Beijing (CN); HEFEI XINSHENG OPTOELECTRONICS TECHNOLOGY CO., LTD., Hefei City (CN)

(72) Inventors: Kui LV, Beijing (CN); Fengzhen LV, Beijing (CN); Kang XIANG, Beijing (CN); Xiao GUO, Beijing (CN); Chen WANG, Beijing (CN); Xinxia ZHANG, Beijing (CN); Qun LI, Beijing (CN)

(73) Assignees: BOE TECHNOLOGY GROUP CO., LTD., Beijing (CN); HEFEI XINSHENG OPTOELECTRONICS TECHNOLOGY CO., LTD., Hefei City (CN)

(21) Appl. No.: 15/239,357

(22) Filed: Aug. 17, 2016

(30) Foreign Application Priority Data
Jan. 6, 2016 (CN) 201610007230.X

(51) Int. Cl. G02F 1/1341; G02F 1/1335; G02F 1/1339

(52) U.S. Cl. CPC G02F 1/1341; G02F 1/1339; G02F 1/133516; G02F 2201/501

(57) ABSTRACT

A liquid crystal display panel and a manufacturing method thereof are provided. The liquid crystal display panel includes an active display region, a packaging region surrounding the active display region, and a fence structure arranged between the active display region and the packaging region, wherein, the fence structure includes multiple cylinders; there is a gap between every two adjacent cylinders, and a width of one side of the gap facing the packaging region is less than that of one side facing the active display region.

### TECHNICAL FIELD

The present disclosure relates to a liquid crystal display panel and a manufacturing method thereof.

### BACKGROUND

A liquid crystal display panel is a key component of a liquid crystal display, and may usually be prepared by cell-assembling a color filter substrate and an array substrate by a cell-assembling process. The preparation course mainly includes steps of: firstly, coating and curing an alignment film on the array substrate and the color filter substrate; secondly, rubbing the cured alignment film, so as to form a groove mark having a certain directivity on a surface of the alignment film, to enable liquid crystal molecules to be arranged accordingly; then, filling a liquid crystal and coating with a sealant; finally, cell-assembling the array substrate and the color filter substrate, and curing the sealant.

However, during a long-term practice project, it is found that during preparing the liquid crystal display panel, the liquid crystal can be polluted by the sealant, alignment film chippings and the like very easily, and then, the polluted liquid crystal may migrate into an active display region, to cause the active display region to be polluted as well, thereby resulting in defects, such as side-Mura, image sticking, Zara and the like caused therefrom, and influencing display performance of the liquid crystal display panel.

### SUMMARY

At least one embodiment of the present disclosure provides a liquid crystal display panel, comprising an active display region, a packaging region surrounding the active display region, and a fence structure arranged between the active display region and the packaging region, wherein the fence structure includes multiple cylinders; there is a gap between every two adjacent cylinders, and a width of one side of the gap facing the packaging region is less than that of one side facing the active display region.

At least one embodiment of the present disclosure provides a manufacturing method for a liquid crystal display panel, comprising: manufacturing a color filter substrate and an array substrate; filling a liquid crystal, and cell-assembling the color filter substrate and the array substrate to form the liquid crystal display panel; wherein, the liquid crystal display panel comprises an active display region and a packaging region surrounding the active display region, a fence structure is arranged between the active display region and the packaging region, the fence structure includes multiple cylinders; there is a gap between every two adjacent cylinders, and a width of one side of the gap facing the packaging region is less than that of one side facing the active display region.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a planar schematic diagram of a liquid crystal display panel provided by an embodiment of the present disclosure;

FIG. 2 is a schematic diagram of a fence structure-based liquid crystal flow direction provided by an embodiment of the present disclosure;

FIG. 3 is a schematic diagram of a fence structure-based liquid crystal flow direction provided by an embodiment of the present disclosure;

FIG. 4 is a schematic diagram of a fence structure-based liquid crystal flow direction provided by an embodiment of the present disclosure;

FIG. 5 is a schematic diagram of a fence structure-based liquid crystal flow direction provided by an embodiment of the present disclosure;

FIG. 6 is a schematic diagram of a fence structure-based liquid crystal flow direction provided by an embodiment of the present disclosure; and

FIG. 7 is a schematic diagram of a fence structure-based liquid crystal flow direction provided by an embodiment of the present disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

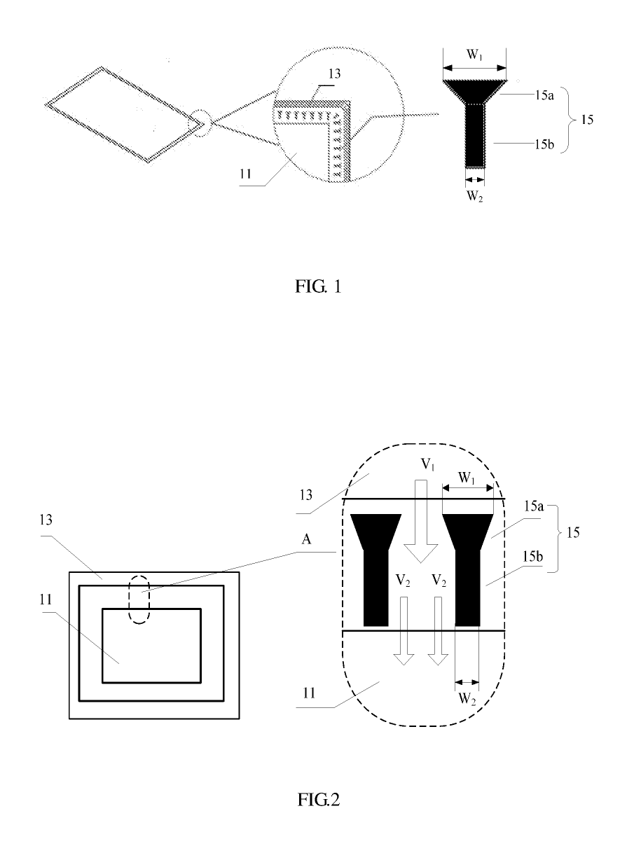

As illustrated in FIG. 1, an embodiment of the present disclosure provides a liquid crystal display panel, comprising an active display region 11 and a packaging region 13 surrounding the active display region 11. A fence structure including cylinders 15 is arranged between the active display region 11 and the packaging region 13; there is a gap between every two adjacent cylinders 15, and an opening area of one side of the gap facing the packaging region 15 is less than that of one side facing the active display region 11.

It should be illustrated that, in this disclosure, a size of the opening area and a width of the gap are both used for indicating a size of an opening, and the opening area is relatively small or the gap is relatively narrow, which indicates that the opening is relatively small. Correspondingly, the opening area is relatively big or the gap is relatively wide, which indicates that the opening is relatively large.

For example, in this description, a width of a cylinder and a width of a gap between adjacent cylinders refer to a dimension of the cylinder or the gap in a direction perpendicular to an extension direction of the cylinder in a planar view (a planar view parallel with the liquid crystal display panel), as illustrated in FIGS. 1 to 6.

For example, the extension direction of the cylinder is a direction from the packaging region to the active display region.

For example, the cylinders are evenly distributed in an annular region between the active display region and the packaging region.

According to a liquid crystal display panel provided by the present disclosure, as a fence structure including the cylinders 15 is arranged between an active display region 11 and a packaging region 13 surrounding the active display region 11, there is a certain gap between every two adjacent cylinders, and an opening area of one side of the gap facing the packaging region is less than that of one side facing the active display region, that is, an opening between every two adjacent cylinders on one side of the packaging region 13 is relatively small, and an opening on one side of the active display region 11 is relatively large. A flow channel with “narrow opening-wide opening” alignment is formed along a direction from the packaging region 13 to the active display region 11. Refer to FIG. 2 for details; the so-called “narrow opening” refers to that the gap between every two adjacent cylinders is relatively narrow, and a cross-sectional area of the gap is relatively small. The so-called “wide opening” refers to that the gap between every two adjacent cylinders is relatively wide, and a cross-sectional area of the gap is relatively large. When a polluted liquid crystal enters the active display region 11 through the flow channel, V₁ is a flow rate of the liquid crystal at the narrow opening, and V₂ is a flow rate of the liquid crystal at the wide opening; according to Bernoulli principle, when an incompressible fluid flows to the wide opening from the narrow opening, the flow rate is lowered, i.e., V₂ is less than V₁, that is, a rate that the polluted liquid crystal migrates to the active display region 11 is lowered, and therefore a pollution degree of the polluted liquid crystal to the active display region 11 is lowered, and many defects, such as side-Mura, image sticking, Zara and the like caused therefrom are suppressed.

Moreover, by comparing the fence structure according to the present disclosure with an enclosure structure (that is, a circle of baffle structure is arranged around the active display region) surrounding the active display region, the gap between every two adjacent cylinders of the fence structure may also balance a pressure difference between both sides of the fence structure in the liquid crystal display panel, which avoids a problem that the liquid crystal display panel cracks due to extrusion during manufacturing and so on, and therefore a product yield is increased.

In an embodiment of the present disclosure, as illustrated in FIG. 1, a cylinder 15 may include a first cylinder part 15a adjacent to the packaging region 13 and a second cylinder part 15b adjacent to the active display region 11, wherein the first cylinder part 15a is connected with the second cylinder part 15b, and a width W₁ of the first cylinder part 15a is greater than a width W₂ of the second cylinder part 15b. A gap between every two cylinders forms a flow channel facing the active display region 11 from the packaging region 13, and the width W₁ of the first cylinder part 15a is greater than the width W₂ of the second cylinder part 15b, which enables an opening of one side of the flow channel adjacent to the packaging region 13 to be relatively small, and an opening of one side adjacent to the active display region 11 to be relatively large. Upon flowing to the active display region 11 from the channel, a polluted liquid crystal flows to a wide opening from a narrow opening, so that a flow rate is lowered.

In the embodiment, a cross-sectional shape of the first cylinder part 15a and a cross-sectional shape of the second cylinder part 15b may be regular shapes, such as a trapezoid, a square or a triangle or the like. Specifically, the first cylinder part 15a may be in a shape of trapezoid or square, and the second cylinder part 15b may be in a shape of trapezoid, square or triangle.

In order to illustrate this point better, it will be specifically illustrated with FIGS. 2 to 5 as an example below.

For example, FIG. 2 is a schematic diagram of a fence structure-based liquid crystal flow direction provided by an embodiment of the present disclosure, where an active display region 11 and a packaging region 13 are illustrated schematically, and after being amplified, a dashed box part A on the left is as illustrated on the right. As illustrated in FIG. 2, with regard to a direction perpendicular to a principal plane inwards, a first cylinder part 15a is in a shape of trapezoid, and a second cylinder part 15b is in a shape of square (rectangle). A short side of the trapezoid and a short side of the rectangle are connected, a width W₁ of the trapezoid is greater than a width W₂ of the rectangle, and an opening between every two adjacent trapezoids is less than an opening between the corresponding two rectangles.

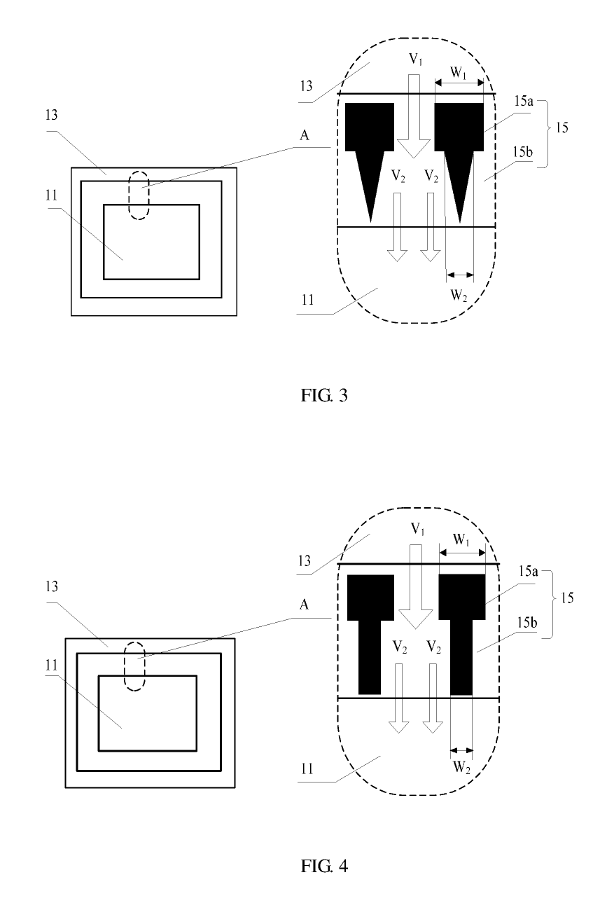

Alternatively, as illustrated in FIG. 3, with regard to a direction perpendicular to a principal plane inwards, a first cylinder part 15a is in a shape of square (rectangle), and a second cylinder part 15b is in a shape of triangle, wherein, a short side of the rectangle is connected with a base side of the triangle, and an opening between every two adjacent rectangles is less than an opening between the corresponding two triangles.

Furthermore, as illustrated in FIG. 4, with regard to a direction perpendicular to a principal plane inwards, a first cylinder part 15a and a second cylinder part 15b are both in a shape of square (rectangle), wherein, a width W₁ of a first rectangle 15a is greater than a width W₂ of a second rectangle 15b, and an opening between the first rectangles 15a is less than an opening between the corresponding second rectangles 15b.

Of course, besides the above-described cylinder in the regular shape, a first cylinder part 15a and a second cylinder part 15b of the cylinder 15 may also be in other irregular shapes, for example, in a direction from a packaging region to an active display region, the first cylinder part 15a and the second cylinder part 15b are gradually decreased in width. For example, two side edges of the first cylinder part 15a and two side edges of the second cylinder part 15b perpendicular to an extension direction in a planar view may be curves. For example, the first cylinder part 15a and the second cylinder part 15b may be in a shape of “horn” in the planar view. The embodiment is not limited thereto, and it is only required that an opening between every two adjacent cylinders 15 facing one side of a packaging region is greater than an opening between the two cylinders facing one side of an active display region 11.

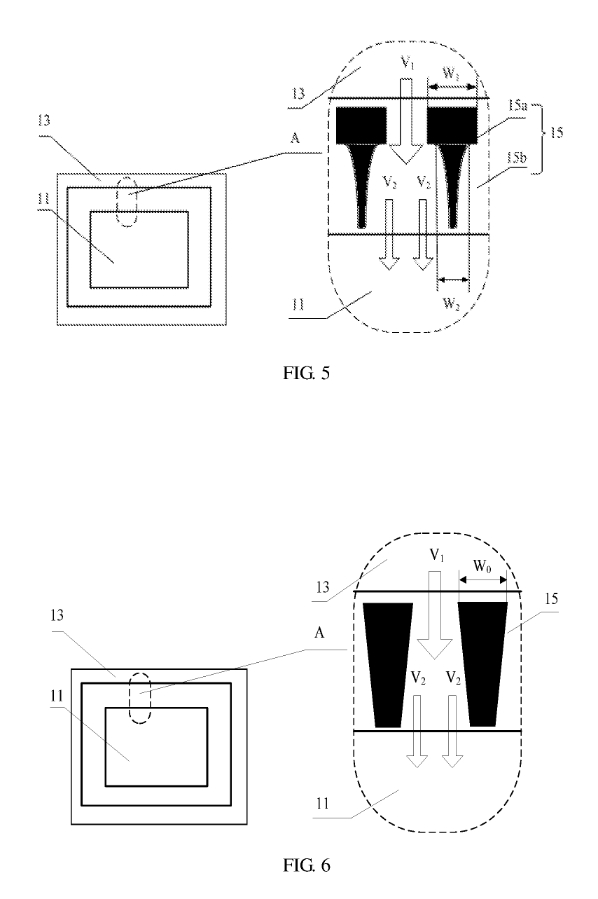

As illustrated in FIG. 5, with regard to a direction perpendicular to a principal plane inwards, a cross section of a first cylinder part 15a is in a shape of rectangle, while a cross section of a second cylinder part 15b is in a shape of “horn”.

It should be understood that, for different products and designs, on the basis of the known first cylinder part 15a and second cylinder part 15b, a length ratio and a width ratio of the first cylinder part 15a and the second cylinder part 15b may be optimized according to a conception of the present disclosure so as to enable a Bernoulli phenomenon to be more obvious, that is, when the liquid crystal flows to an active display region 11 from a gap between every two adjacent cylinders, V₂ should be less than V₁.

A case that the cylinder 15 includes the first cylinder part 15a and the second cylinder part 15b is described in detail above; in another embodiment of the present disclosure, a cylinder 15 may also be a variable-cross-section cylinder, and moreover, along a direction from a packaging region 13 to an active display region 11, the cylinder 15 is gradually decreased in width W₀, which enables an opening between every two adjacent two cylinders 15 to gradually increase from the packaging region 13 to active display region 11, thereby forming a flow channel gradually widened.

In the embodiment, the cylinder 15 may be a cylinder in a regular shape, such as one of a trapezoidal cylinder and a triangular prism. As illustrated in FIG. 6, with regard to a direction perpendicular to a principal plane inwards, a cylinder 15 is in a shape of trapezoid; a long side of the trapezoid is adjacent to a packaging region 13, a short side of the trapezoid is adjacent to an active display region 11, and along a direction from the packaging region 13 to the active display region 11, the trapezoid is gradually decreased in width W₀, and an opening between every two adjacent trapezoids gradually increases.

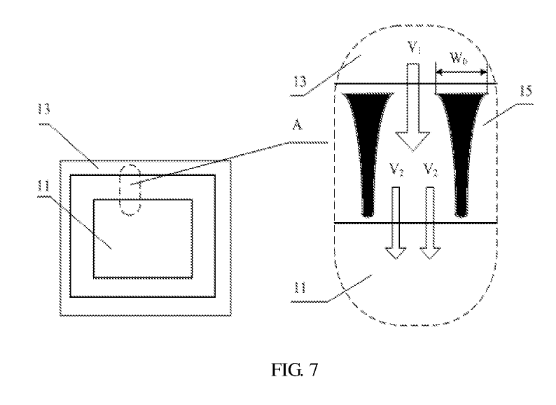

Of course, the cylinder 15 may also be a cylinder in an irregular shape, such as a “horn” shape, or both sides of the cylinder are in a shape of step, a fold line and the like. As illustrated in FIG. 7, with regard to a direction perpendicular to a principal plane inwards, a cylinder 15 is in a shape of “inverted / \”, and along a direction from a packaging region 13 to an active display region 11, the cylinder is gradually decreased in width W₀.

As described above, the present disclosure may also optimize a width of the cylinder 15 further, and for different products and designs, a specific value of the cylinder will be adjusted.

In addition, the fence structure according to the present disclosure also has a further advantage. The fence structure may be formed through exposure and development by adopting an existing material, such as resin and the like, thus a new material does not need to be researched and developed, thereby saving cost; meanwhile, the fence structure is also simple in structure, and easy to manufacture. Specifically, the fence structure may be arranged on an array substrate or a color filter substrate of the liquid crystal display panel, and is separately shaped with the existing resin material by patterning processes, such as exposure, development and the like. Alternatively, the fence structure may be arranged on a color filter substrate of the liquid crystal display panel, and is shaped together with a planarization layer or a spacer of the color filter substrate with a material identical with that of the planarization layer or the spacer, and thus, a process step can be saved, and a manufacturing course of the liquid crystal display panel is simplified.

Furthermore, the present disclosure also optimizes the fence structure further. Specifically, a height of the fence structure may be equal to or less than a cell gap of the liquid crystal display panel, so that a peripheral gap of the panel cannot be influenced. For example, a height of the fence structure may be equal to the cell gap, or less than the cell gap by 0.2 to 0.5 μm. Of course, for different products and designs, this numerical value range will be adjusted.

Moreover, the fence structure should be proper in position on the liquid crystal display panel: it should be guaranteed that the fence structure is not in contact with a packaging region, and keeps a certain distance from the packaging region, for example, the fence structure may be apart away from the packaging region by 0 to 0.5 mm, preferably 0.2 mm to 0.5 mm, which prevents coating of a sealant from a harmful effect; it should be also guaranteed that the sealant does not enter an active display region, thereby preventing a display effect from a harmful effect.

On the other hand, the present disclosure further provides a manufacturing method for a liquid crystal display panel, and for example, the manufacturing method for the liquid crystal display panel may comprise: forming a color filter substrate and an array substrate; filling a liquid crystal, and cell-assembling to form the liquid crystal display panel. The liquid crystal display panel comprises an active display region and a packaging region surrounding the active display region; a fence structure including cylinders is arranged between the active display region and the packaging region; there is a gap between every two adjacent cylinders, and an opening area one side of the gap facing the packaging region is less than that of one side facing the active display region.

According to the manufacturing method for the liquid crystal display panel provided by the present disclosure, during manufacturing a color filter substrate or array substrate, a fence structure including cylinders is arranged between an active display region and a packaging region surrounding the active display region, there is a gap between every two adjacent cylinders, and an opening area of one side of the gap facing the packaging region is less than that of one side facing the active display region, thus enabling every two adjacent cylinders to form a flow channel with narrow opening-wide opening alignment from the packaging region to the active display region; when a liquid crystal enters the active display region through the flow channel from the packaging region, which is equivalent to that the liquid crystal flows to a wide opening from a narrow opening, so that a flow rate decreases, i.e., a rate that a peripheral liquid crystal migrates into the active display region decreases, thereby lowering a peripheral polluted liquid crystal in doping level on the liquid crystal in the active display region, and therefore, many defects, such as side-Mura, image sticking, Zara and the like caused therefrom are improved.

The manufacturing method for the liquid crystal display panel is to form the fence structure during manufacturing the color filter substrate and the array substrate, thus saving process steps, and meanwhile, a new material does not need to be researched and developed, thereby saving cost.

As described above, a corresponding flow channel may be formed by forming the fence structure on the array substrate or the color filter substrate, and then, the array substrate and the color filter substrate are cell-assembled to form the liquid crystal display panel.

One embodiment of the present disclosure is to form the fence structure during manufacturing a color filter substrate so as to implement the present disclosure. The embodiment may specifically include steps of:

Step I: forming a pixel matrix in a region corresponding to an interior of a sealant on a glass substrate.

A region corresponding to the region where the pixel matrix is located is an active display region, and a region corresponding to a region where the sealant is located is a packaging region.

These steps are identical with those during conventional manufacturing of a color filter substrate in the prior art, and will not be illustrated in detail here.

Step II: forming a planarization layer and a fence structure on the glass substrate.

Coating an existing material that is usually used for forming the planarization layer, such as epoxy resin and the like, onto the glass substrate, and then shaping the planarization layer and the fence structure together on the glass substrate by a patterning process, usually, the patterning process including coating, exposure, development and the like.

Step III: forming a spacer on the glass substrate.

The step is identical with that during conventional manufacturing of the color filter substrate in the prior art, and will not be illustrated in detail here.

Step IV: filling a liquid crystal into the active display region of the color filter substrate.

Manufacturing of the color filter substrate is completed through the above steps.

Step V: completing manufacturing of an array substrate by the patterning process.

Step VI: cell-assembling the formed array substrate and color filter substrate to form a liquid crystal display panel.

The cylinder of the fence structure may be selected from any one of the above-described cylinders, for example, the cylinder may include a first cylinder part adjacent to the packaging region and a second cylinder part adjacent to the active display region, wherein a width of the first cylinder part is greater than that of the second cylinder part, or it may be that the closer to the packaging region, the bigger the width; in a word, two adjacent cylinders form a flow channel with narrow opening-wide opening alignment from the packaging region to the active display region; when the liquid crystal display panel is subjected to extrusion from the outside to enable a peripheral liquid crystal to flow into the active display region through the flow channel, the peripheral liquid crystal flows to a wide opening from a narrow opening, and therefore, a flow rate decreases.

Moreover, the embodiment is not limited thereto; when the fence structure is arranged on the color filter substrate so as to implement the present disclosure, the fence structure may also be shaped together with a spacer, or may also be separately shaped. For example, after forming the planarization layer, an existing material that is usually used for forming the spacer is coated onto the glass substrate, and the fence structure and the spacer are shaped together by a patterning process. Alternatively, before and after forming the spacer, a material identical with or different from that of the spacer/planarization layer is coated onto the glass substrate, and the fence structure is shaped by a patterning process.

It should be noted that, a whole panel manufacturing course may include one or more steps, and may also include steps that are not mentioned by the embodiment of the present disclosure, which will not be limited by the embodiment of the present disclosure.

Moreover, still another embodiment of the present disclosure is to form the fence structure during manufacturing an array substrate so as to implement the present disclosure. The embodiment may specifically include steps of:

Step I: forming a transparent conducting thin film (ITO) in a region corresponding to an interior of a sealant on a glass substrate.

This step is identical with that during conventional manufacturing of a color filter substrate in the prior art, and will not be illustrated in detail here, wherein a region corresponding to an ITO layer is an active display region.

Step II: coating resin onto the ITO layer, and forming the fence structure by a patterning process.

Step III: filling a liquid crystal into the active display region of the array substrate.

Step IV: completing manufacturing of the color filter substrate by a patterning process.

Step V: cell-assembling the formed array substrate and color filter substrate to form a liquid crystal display panel.

Similarly, during manufacturing the liquid crystal display panel, the cylinders of the fence structure may all be selected from any one of the above-described cylinders, which will not be specifically limited by the embodiment.

The foregoing embodiments merely are exemplary embodiments of the disclosure, and not intended to define the scope of the disclosure, and the scope of the disclosure is determined by the appended claims.

The present application claims priority of Chinese Patent Application No. 201610007230.X filed on Jan. 6, 2016, the present disclosure of which is incorporated herein by reference in its entirety as part of the present application.

1. A liquid crystal display panel, comprising an active display region, a packaging region surrounding the active display region, and a fence structure arranged between the active display region and the packaging region, wherein the fence structure includes multiple cylinders; there is a gap between every two adjacent cylinders, and a width of one side of the gap facing the packaging region is less than that of one side facing the active display region.

2. The liquid crystal display panel according to claim 1, wherein, in a planar view, along a direction from the packaging region to the active display region, the cylinders are gradually reduced in width.

3. The liquid crystal display panel according to claim 2, wherein, each of the cylinders is a trapezoidal cylinder or a triangular prism.

4. The liquid crystal display panel according to claim 1, wherein, an extension direction of each of the cylinders is a direction from the packaging region to the active display region.

5. The liquid crystal display panel according to claim 1, wherein, each of the cylinders includes a first cylinder part adjacent to the packaging region and a second cylinder part adjacent to the active display region, wherein the first cylinder part is connected with the second cylinder part, and a width of the first cylinder part is greater than that of the second cylinder part.

6. The liquid crystal display panel according to claim 5, wherein, in a planar view, the first cylinder part has a shape of trapezoid or square, and the second cylinder part has a shape of trapezoid, square or triangle.

7. The liquid crystal display panel according to claim 6, wherein, in the planar view, the first cylinder part has a shape of trapezoid, and the second cylinder part has a shape of square.

8. The liquid crystal display panel according to claim 1, wherein, the liquid crystal display panel comprises a color filter substrate; the fence structure is arranged on the color filter substrate, and the fence structure is shaped together with a planarization layer or a spacer in the color filter substrate.

9. The liquid crystal display panel according to claim 1, wherein, a dimension of the fence structure in a direction perpendicular to the liquid crystal display panel is less than or equal to a cell gap of the liquid crystal display panel.

10. The liquid crystal display panel according to claim 9, wherein, the dimension of the fence structure in the direction perpendicular to the liquid crystal display panel is less than the cell gap by 0.2 μm to 0.5 μm.

11. The liquid crystal display panel according to claim 1, wherein, a distance between the fence structure and the packaging region is 0 to 0.5 mm.

12. The liquid crystal display panel according to claim 1, wherein, the cylinders are evenly distributed in an annular region between the active display region and the packaging region.

13. A manufacturing method for a liquid crystal display panel, comprising:
manufacturing a color filter substrate and an array substrate;
filling a liquid crystal, and cell-assembling the color filter substrate and the array substrate to form the liquid crystal display panel;
wherein, the liquid crystal display panel comprises an active display region and a packaging region surrounding the active display region,
a fence structure is arranged between the active display region and the packaging region, the fence structure includes multiple cylinders; there is a gap between every two adjacent cylinders, and a width of one side of the gap facing the packaging region is less than that of one side facing the active display region.

14. The manufacturing method for the liquid crystal display panel according to claim 13, wherein the fence structure is arranged on the color filter substrate of the liquid crystal display panel, and the fence structure is shaped together with a planarization layer or a spacer in the color filter substrate.
